(19) United States
(12) Patent Application Publication
(10) Pub. No.: US 2013/0036380 A1
(43) Pub. Date: Feb. 7, 2013

(54) Graphical User Interface for Tracking and Displaying Views of an Application

(71) Applicant: William James Thomas Symons, Encinitas, CA (US)

(72) Inventor: William James Thomas Symons, Encinitas, CA (US)

(73) Assignee: APPLE INC., Cupertino, CA (US)

(21) Appl. No.: 13/196,833

(22) Filed: Aug. 2, 2011

(51) Int. Cl. G06F 3/048

(52) U.S. Cl. 715/804

(57) ABSTRACT

A user interface element of a graphical user interface (GUI) presents user-selectable visual representations of views of an application. The current state of each view is stored, allowing a user to select a view for display by selecting a visual representation of the view from the user interface element. In some implementations, groups of visual representations of related views are presented in the user interface element in compressed or expanded display formats, depending on whether a member of the group corresponds to a currently selected view. In some implementations, a user can select a compressed group of visual representations, causing the visual representations to be expanded even if a member of the group does not correspond to the currently selected view. In some implementations, the group can be visually augmented to indicate the status of the one or more views in the group.

### TECHNICAL FIELD

This disclosure relates generally to graphical user interfaces (GUIs), and more particularly to GUIs for tracking and displaying views of an application.

### BACKGROUND

Some software applications include editors that allow a user to create, modify and view content, such as text, charts and graphics. Some examples of applications include reporting applications, presentation programs and spreadsheets. During an editing session, a user may create several different views of content. For example, a user may create a first view of data that includes a pie chart and a second view that includes a bar chart. The user may also wish to modify the first or second views to create additional, different views of content. While working on a given view, a user may desire to track and display other views quickly without leaving the active view to open or close a file or navigate a menu system.

### SUMMARY

A user interface element of a graphical user interface (GUI) presents user-selectable visual representations of views of an application. The current state of each view is stored, allowing a user to select a view for display by selecting a visual representation of the view from the user interface element. In some implementations, groups of visual representations of related views are presented in the user interface element in compressed or expanded display formats, depending on whether a member of the group corresponds to a currently selected view. In some implementations, a user can select a compressed group of visual representations, causing the visual representations to be expanded, even if a member of the group does not correspond to the currently selected view. In some implementations, the group can be visually augmented (e.g., different color and/or width of borders around the group) to indicate the status of the one or more views in the group (e.g., old view, new view or selected view).

In some implementations, a method comprises: generating a GUI for displaying a selected view of an application; and generating a user interface element of the GUI, the user interface element configured for displaying groups of one or more visual representations of views of the application, where the groups of views are in a compressed or expanded display format based on whether a member of the group corresponds to the selected view.

In some implementations, a method comprises: generating a graphical user GUI for displaying a selected view; generating a user interface element for the GUI, the user interface element configured for displaying groups of visual representations of views; receiving a first input selecting a group of visual representations from the user interface element; and displaying visual representations in the GUI using a compressed or expanded display format, where the display format is selected based on whether a member of the selected group corresponds to the selected view.

Particular implementations of the disclosed implementations provide one or more advantages, including but not limited to: 1) providing groups of visual representations in a user interface element of the GUI to indicate a history of the user's views, and 2) facilitating the user's review, navigation and selection of views from a single location in a single GUI.

Other implementations can include systems, apparatuses and computer-readable mediums. The details of one or more disclosed implementations are set forth in the accompanying drawings and the description below. Other features, aspects, and advantages will become apparent from the description, the drawings and the claims.

### BRIEF DESCRIPTION OF THE DRAWINGS

FIGS. 1-10 illustrate a GUI for tracking and displaying views of an application.

FIG. 11 is a flow diagram of an exemplary process for generating a GUI for tracking and displaying views of an application.

FIG. 12 is a block diagram of an operating environment for a device capable of generating a GUI for tracking and displaying views of an application.

FIG. 13 is a block diagram of an exemplary device architecture that implements the features and processes described with reference to FIGS. 1-12.

Like reference-symbols in the various drawings indicate like elements.

### DETAILED DESCRIPTION

Exemplary GUI for Tracking and Displaying Views

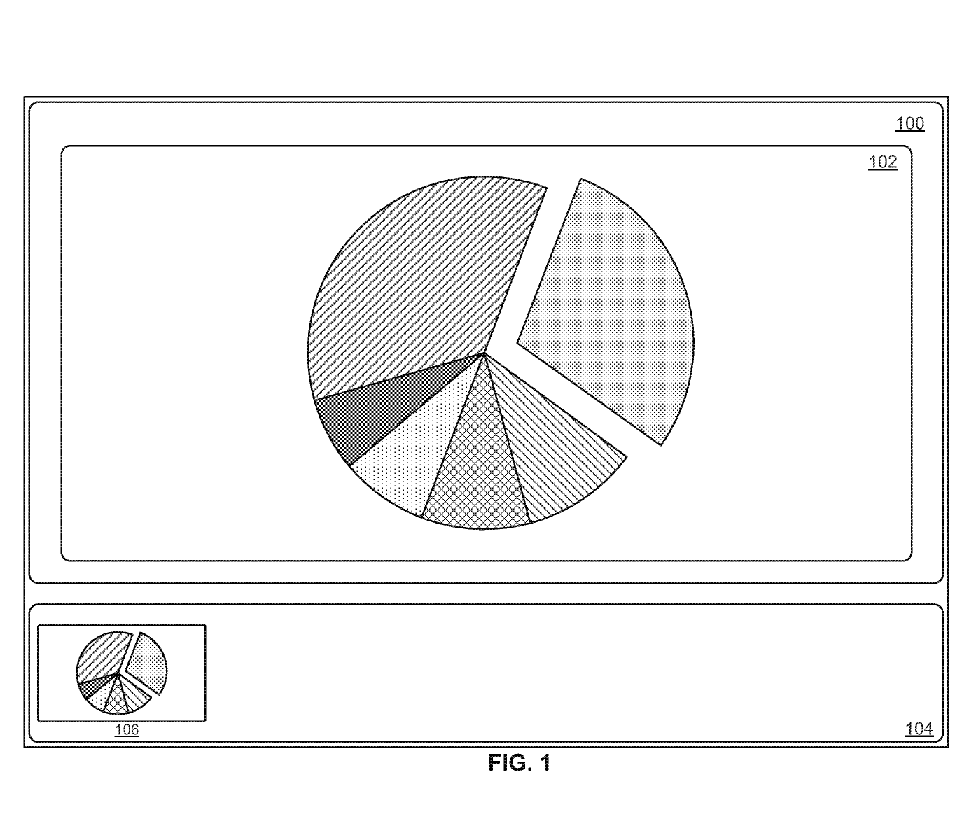

FIG. 1 illustrates a GUI 100 for tracking and displaying views of an application. In some implementations, GUI 100 can include selected view 102, user interface element 104 and visual representation 106. A view can be a view of an application, such as a reporting application containing dynamic views (e.g., graphs, charts) that change due to modified filters and settings. In the example shown, the application is a reporting application and view 102 is a pie chart.

User interface element 104 displays and tracks distinct views of an application and can be presented at a fixed location of GUI 100 or can be a separate element that can be moved around GUI 100 by the user or an application. In the latter case, user interface element 104 can be a semi-transparent overlay on GUI 100. User interface element 104 displays groups of one or more visual representations 106. In the example shown, visual representation 106 represents view 102.

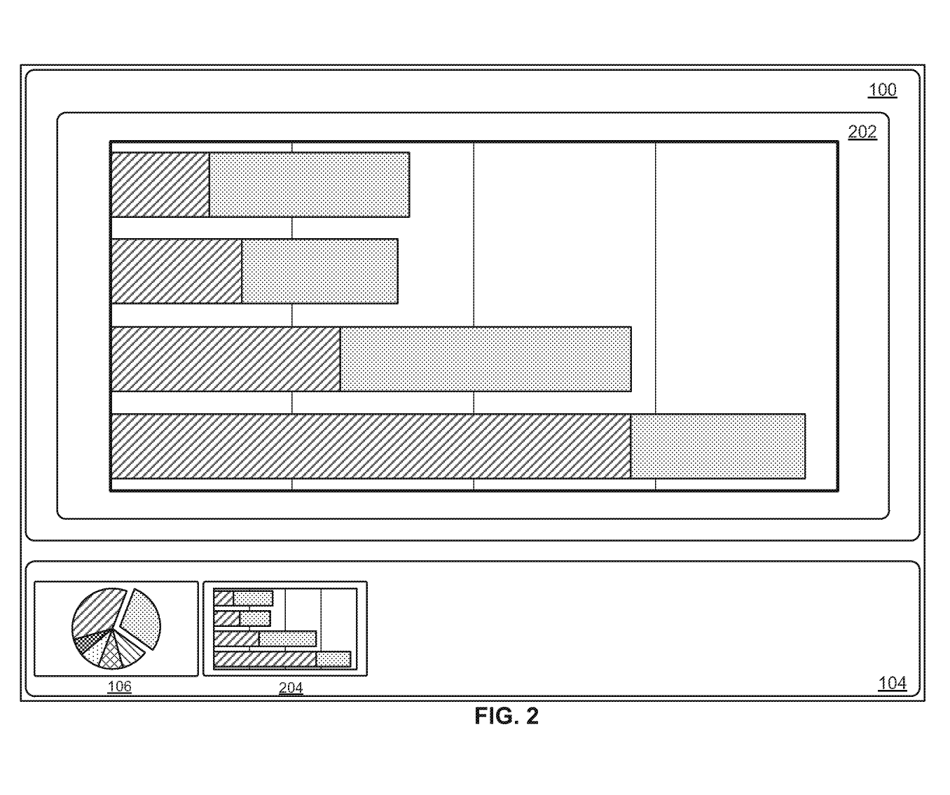

FIG. 2 illustrates a GUI 100 for tracking and displaying views of an application. In this example, the user changes to new selected view 202 (e.g., a bar graph). Visual representation 204 of view 202 is displayed in user interface element 104 and to the left of visual representation 106 to indicate its place in the user's view history. A user can select one of the visual representations 106, 204 to display the corresponding view in GUI 100.

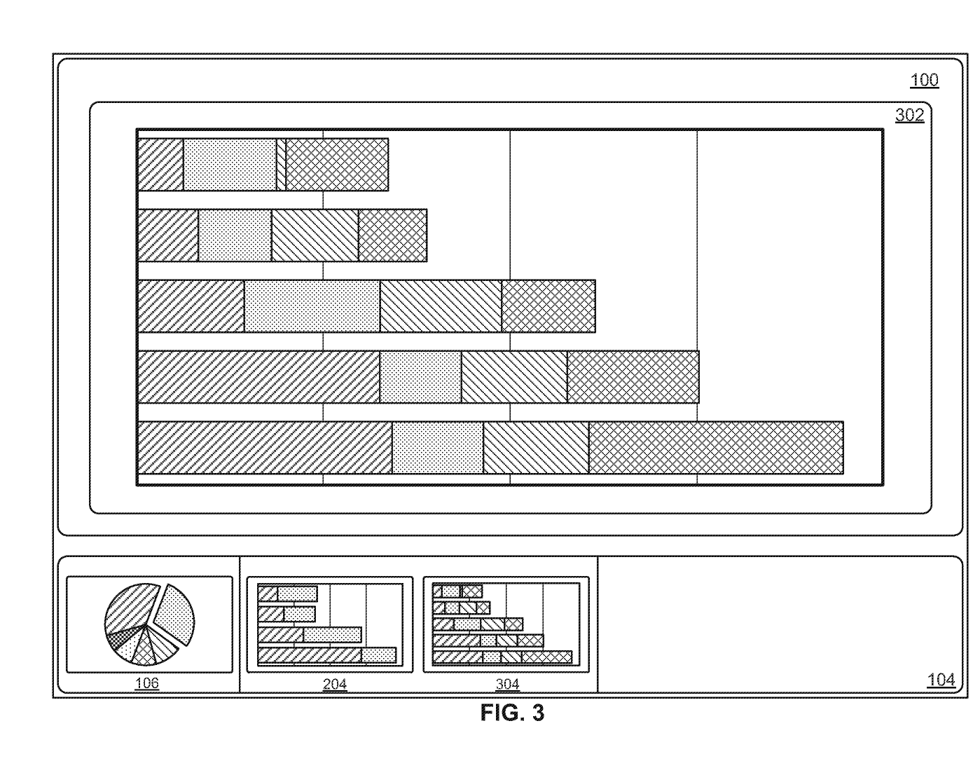

FIG. 3 illustrates a GUI 100 for tracking and displaying views of an application. In this example, the user modified view 202 to generate view 302. For example, the user may have altered filters in the reporting application to generate view 302 from view 202. Visual representation 304 for view 302 is displayed in user interface element 104, together with visual representations 106 and 204. Because views 202, 302 are related, there visual representations 204, 304 are displayed in a group in user interface element 104. In the example shown, visual representations 204, 306 are displayed in a row in user interface element 104 and are surrounded by a border to indicate their grouped status.

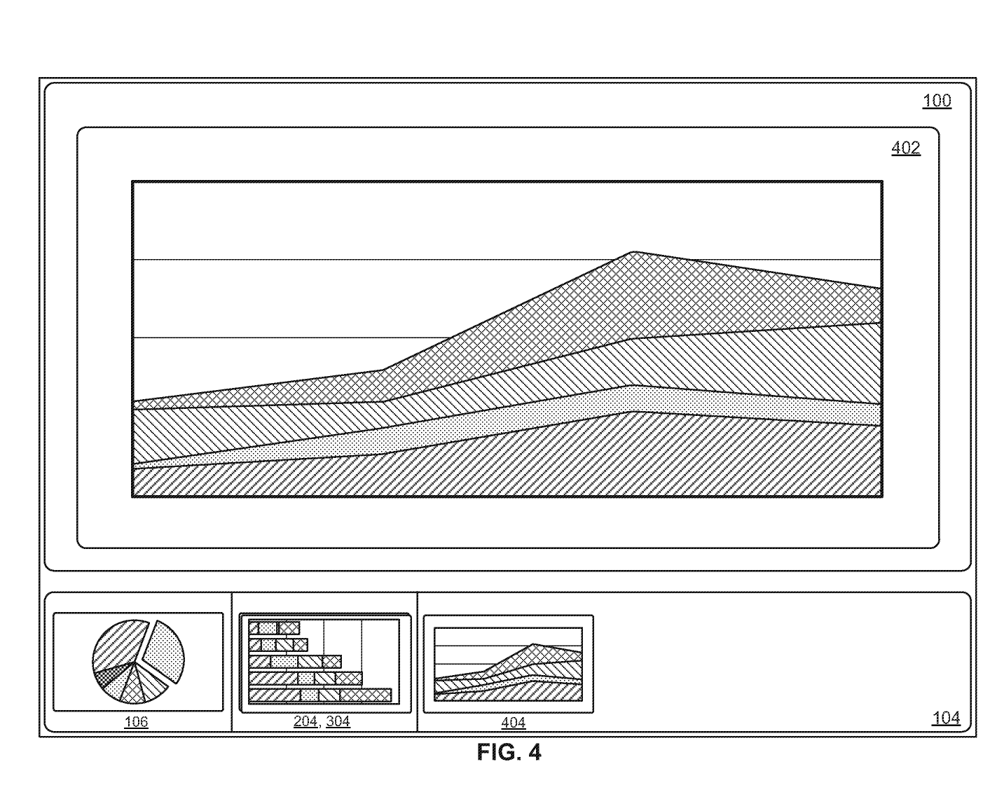

As will be discussed in reference to FIG. 4, groups of visual representations can be displayed using different display formats (e.g., displayed as a stack) depending on whether a member of the group is the currently selected view or not. In this example, view 302 is the currently selected view, resulting in visual representations 204, 304 of views 202, 302 being displayed in an expanded display format (e.g., a horizontal row) in user interface element 104. Visual representations can also be visually augmented to indicate their status. For example, visual representation 106 represents an old view 102 and could have a black border with a standard thickness to indicate that it is a non-selected old view or a blue border to indicate it is a selected old view. Similarly, visual representation 304 represents a currently selected view and could have a green, thicker border (e.g., 2× the standard thickness) to indicate its selected view status.

FIG. 4 illustrates a GUI 100 for tracking and displaying views of an application. In this example, the user changes to another new view 402 and the previous group of views including visual representations 204, 304 is compressed into a stack. Visual representation 404 representing currently selected view 402 is also displayed in user interface element 104. As can be observed, user interface element 104 effectively tracks the user's view history over time where stacks of visual representations indicate multiple versions of a view (hereafter referred to as “related views”). In some implementations, if there are a large number of views in a stack, a badge or other visual indicator can be attached or otherwise associated with the stack to indicate the number of views in the stack.

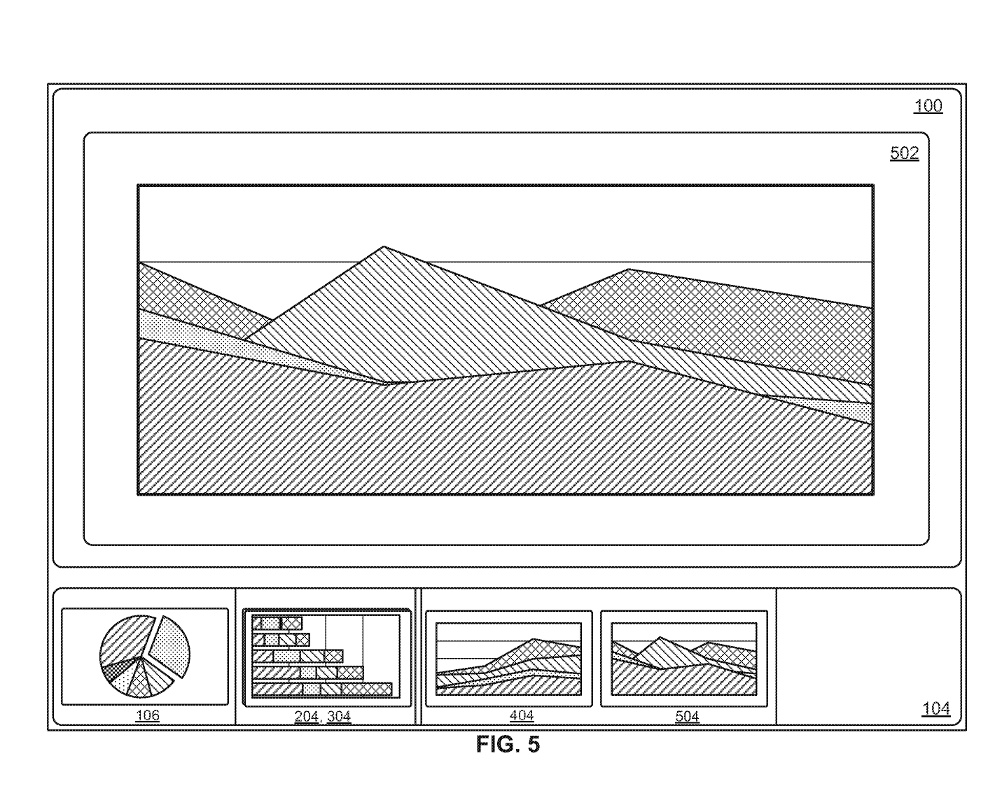

FIG. 5 illustrates a GUI 100 for tracking and displaying views of an application. In this example, the user has altered the filters for the current selected view 402 to create new view 502, and another group of visual representations 404, 504 is created and displayed in user interface element 104. The group of visual representations 404, 504 is displayed in an expanded display format in user interface element 104 because a member of the group (view 504) is the currently selected view. Other display formats are also possible.

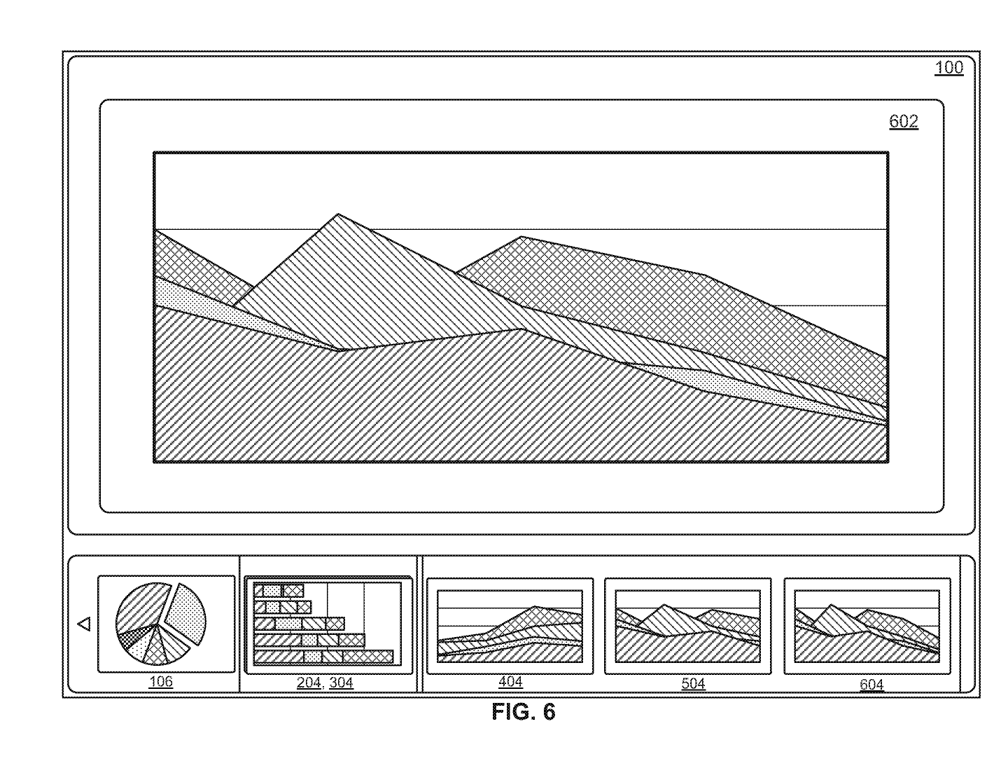

FIG. 6 illustrates a GUI 100 for tracking and displaying views of an application. In this example, the user alters the filters for the currently selected view 502 to create another view 602 to add to the group. The group now includes visual representations 404, 504 and 604. Visual representations 404, 504, 604 are displayed in a horizontal row in user interface element 104 (as opposed to a stack) because a member (view 602) of the group is the currently selected view.

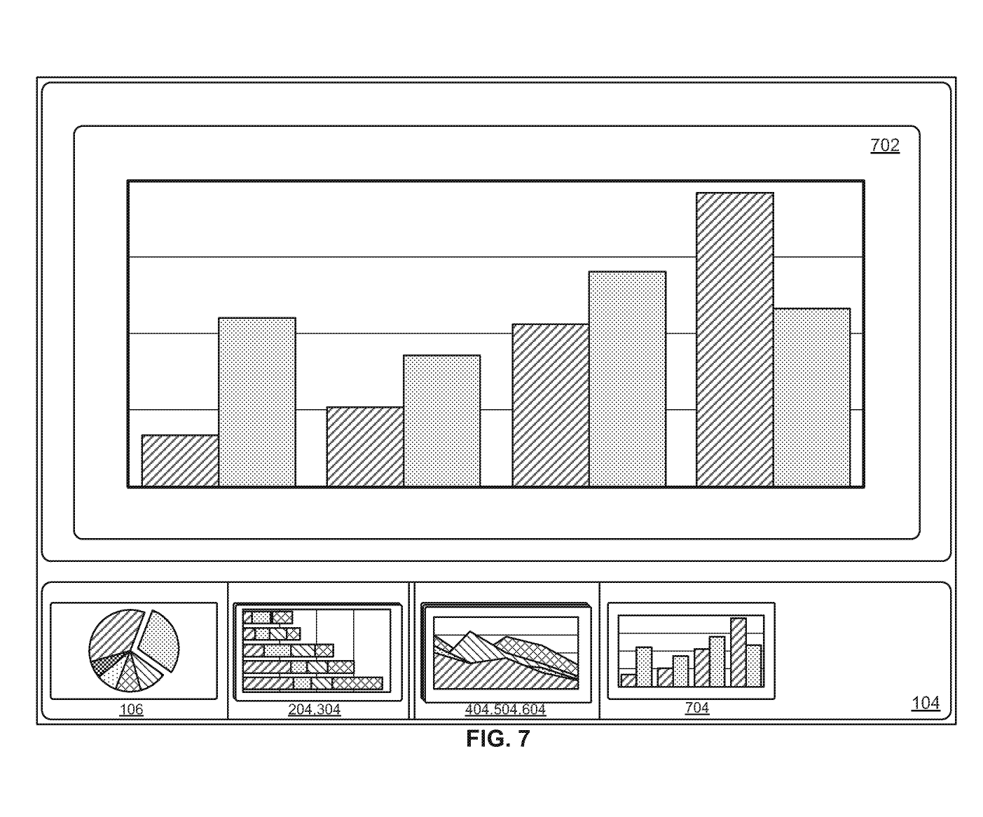

FIG. 7 illustrates a GUI 100 for tracking and displaying views of an application. In this example, the user changes to a new view a third time and the previous group of views represented by visual representations 404, 405, 604 are compressed into a stack in user interface element 104. At this point in the view history, there are four groups of views in user interface element 104: a first group including a single visual representation 106, a second group including a stack of visual representations 204, 304, a third group including a stack of visual representations 404, 504, 604 and a fourth group including a single visual representation 704.

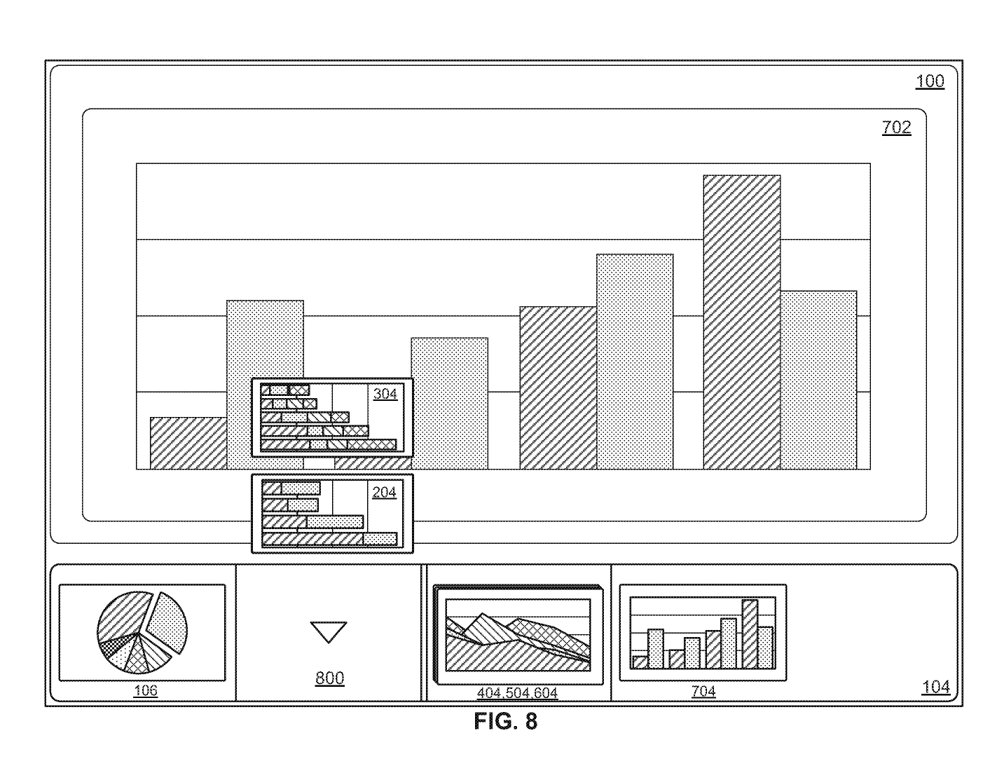

FIG. 8 illustrates a GUI 100 for tracking and displaying views of an application. In this example, the user selects the first stack of visual representations. The selection can be a mouse click, mouse-over or touch input. In response to the selecting, the stack is expanded to reveal visual representations 204, 304 in the stack. The expansion of the stacked views can take a variety of display formats, such as a grid or a path (e.g., curved path of views), which selection can depend on the number of views in the stack. The expansion can be at least partially outside user interface element 104 and into GUI 100 as shown in FIG. 8.

After the selecting of the first stack, view 702 remains the currently displayed view. This feature allows the user to expand views in a stack in user interface element 104, even when a member of the group is not the currently selected view. In some implementations, a compression button 800 occupies the position of the stack in user interface element 104 when the stack is expanded. Selecting button 800 recompresses the stack in user interface element 104.

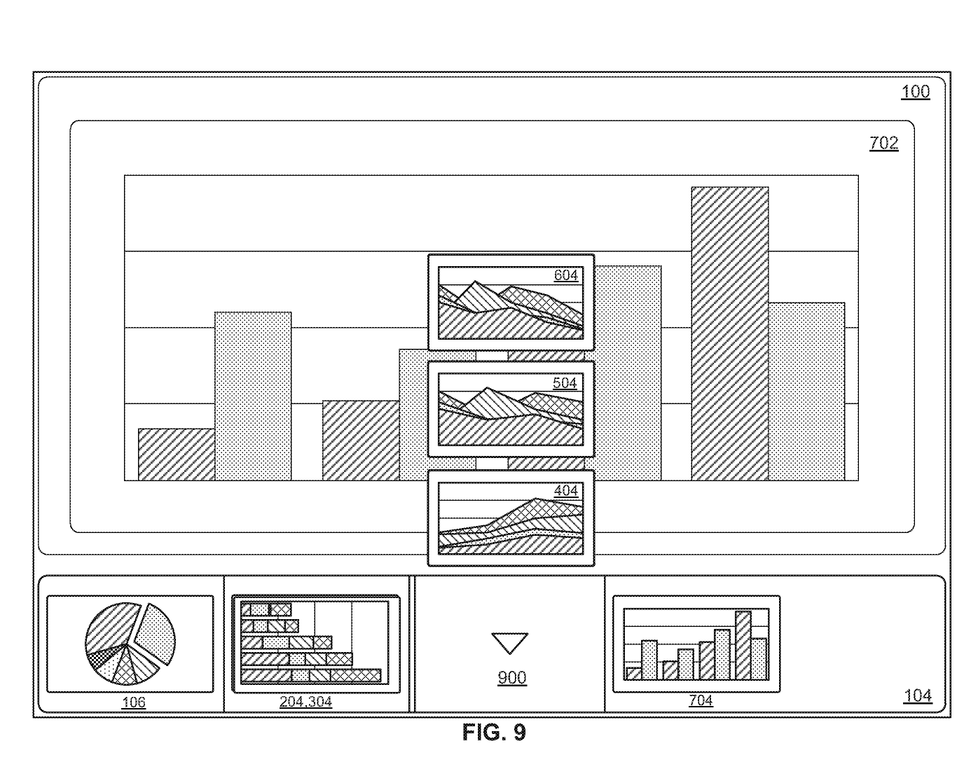

FIG. 9 illustrates a GUI 100 for tracking and displaying views of an application. In this example, the user selects the second stack in user interface element 104, resulting in the expansion of the stack. In this example, the second stack is expanded to reveal visual representations 404, 504, 604. The expansion can be along a curved path in GUI 100. The user can select any one of visual representations 404, 504, 604 to be the selected view. Button 900 can be used to recompress the stack in user interface element 104.

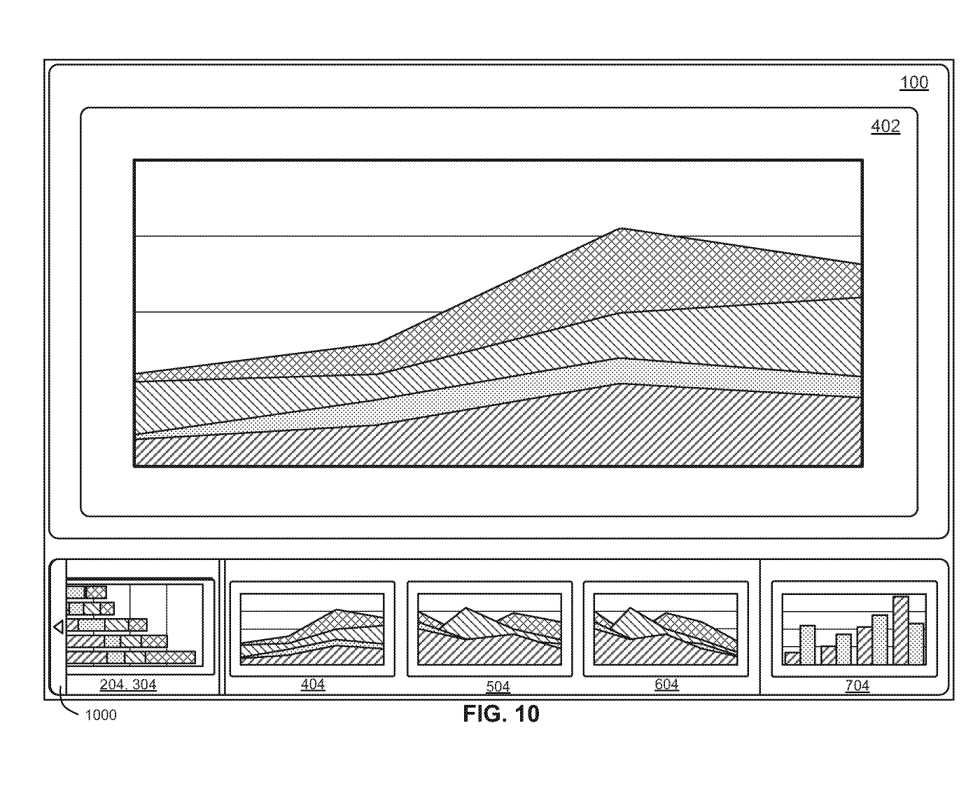

FIG. 10 illustrates a GUI 100 for tracking and displaying views of an application. As shown in FIG. 10, the selection of the first view representation 404 in FIG. 9 results in the first view 402 being the currently selected view in FIG. 10. Because 404 is the currently selected view, its group of visual representations is displayed in expanded display format (e.g., a horizontal row) in user interface element 104. At this point in the view history, user interface element 104 includes a first stacked group of visual representations 204, 304, a second group of visual representations 404, 504, 604 expanded horizontally within user interface element 104 and a third group including a single, unselected visual representation 704. A navigation control 1000 is added for allowing the user to scroll the groups in user interface element 104. In some implementations, control 1000 appears when user interface element 104 is fully occupied to allow for more groups to be tracked and displayed than can fit in the visible area of user interface element 104.

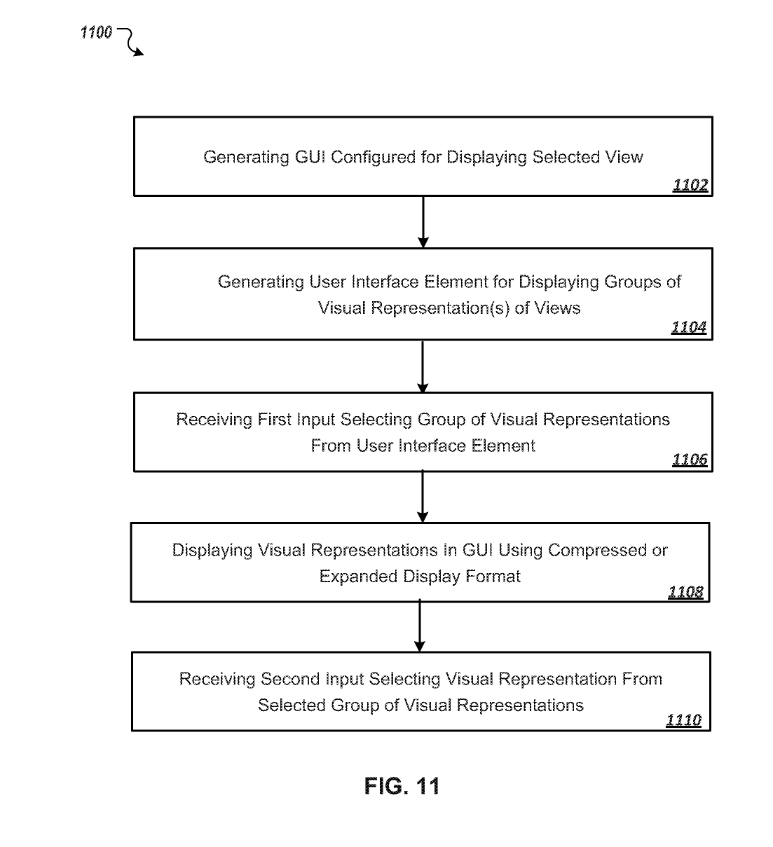

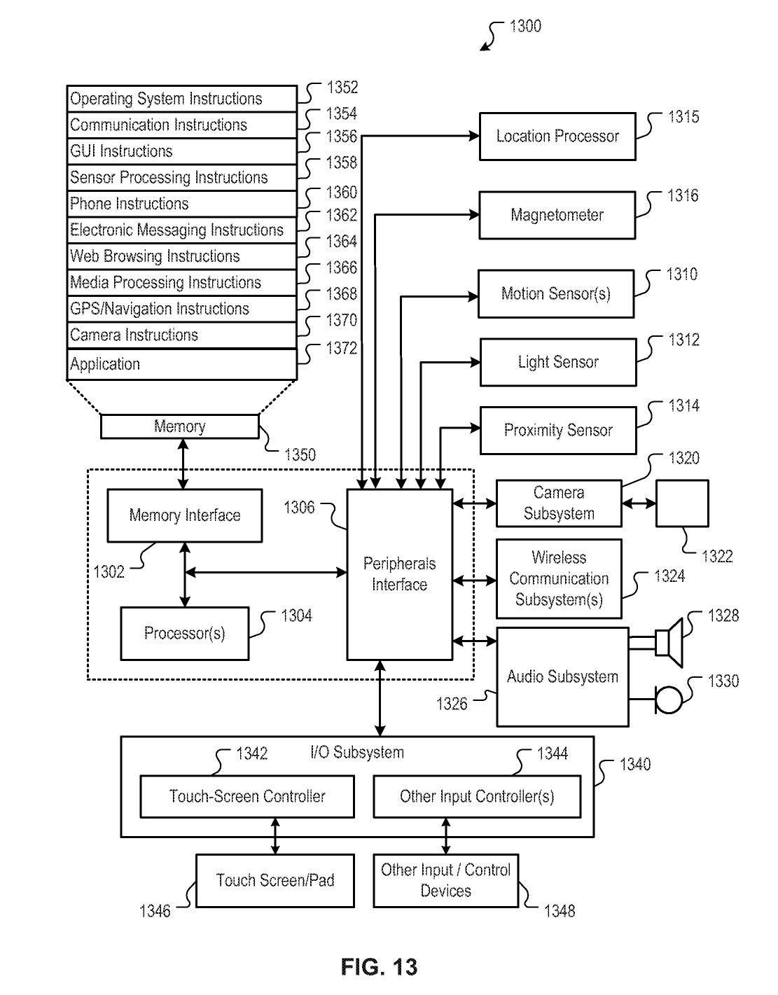

FIG. 11 is a flow diagram of an exemplary process 1100 for generating a GUI for tracking and displaying views of an application. Process 1100 can be implemented in architecture 1300 described in reference to FIG. 13.

In some implementations, process 1100 can begin by generating a GUI configured for displaying a selected view (1102). Process 1100 can continue by generating a user interface element for displaying groups of one or more visual representations of views (1104). The groups can be visually augmented (e.g., different color and/or width of borders) to indicate the status of the views in the group. Process 1100 can continue by receiving first input selecting a group of visual representations from the user interface element (1106). Process 1100 can continue by displaying visual representations in the GUI using a compressed or expanded display format (1108). For example, the compressed display format can be a stack and the expanded display format can be a horizontal row in the user interface element or a grid or path (e.g., a curved path) at least partially outside the user interface element. The display format can be selected based on whether a member of the group is the currently selected view. Process 1100 can continue by receiving a second input selecting for display a visual representation from the selected group of visual representations (1110).

Other Exemplary Applications

In some implementations, process 1100 can operate on Web pages of Web sites that are navigated by a user. In such an application, the home page of each Web site can be an old or new view in the user interface element, and subpages of the same Web site can be treated as related views. For example, subpages from a single Website can be compressed into a stack on the user interface element with a thumbnail image of the home page being at the top of the stack. The order of the views in the user interface element can indicate the user's search history. A user can select a group of visual representations (e.g., thumbnail images of the Web pages) from the user interface element, causing the stack to expand into a display format that is selected based on whether a member of the group is a currently selected view, as described in reference to FIGS. 1-10. In this example application, the user interface element can be included in a browser GUI.

In some implementations, process 1100 can operate on media items in editing applications, such as digital photos. In a digital photo editing application, each original photo being edited can be a view in the user interface element. Each time an original photo is edited, a thumbnail image of the edited version is added to the group in the user interface element. The group can be compressed or expanded as described in reference to FIGS. 1-10. Other media items can also be edited using the user interface element and disclosed tracking and display, such as audio, videos and podcasts. In these application, the user interface element can be included in a GUI for the editing applications, such as an editing window.

In some implementations, process 1100 can operate on text documents in a word processing application. In a word processing application, the first page of each original document being edited can be a view in the user interface element. Each time an original document is edited, a thumbnail image of the first page of the edited document is added to the group in the user interface element. The group can be compressed or expanded as described in reference to FIGS. 1-10.

Exemplary Operating Environment

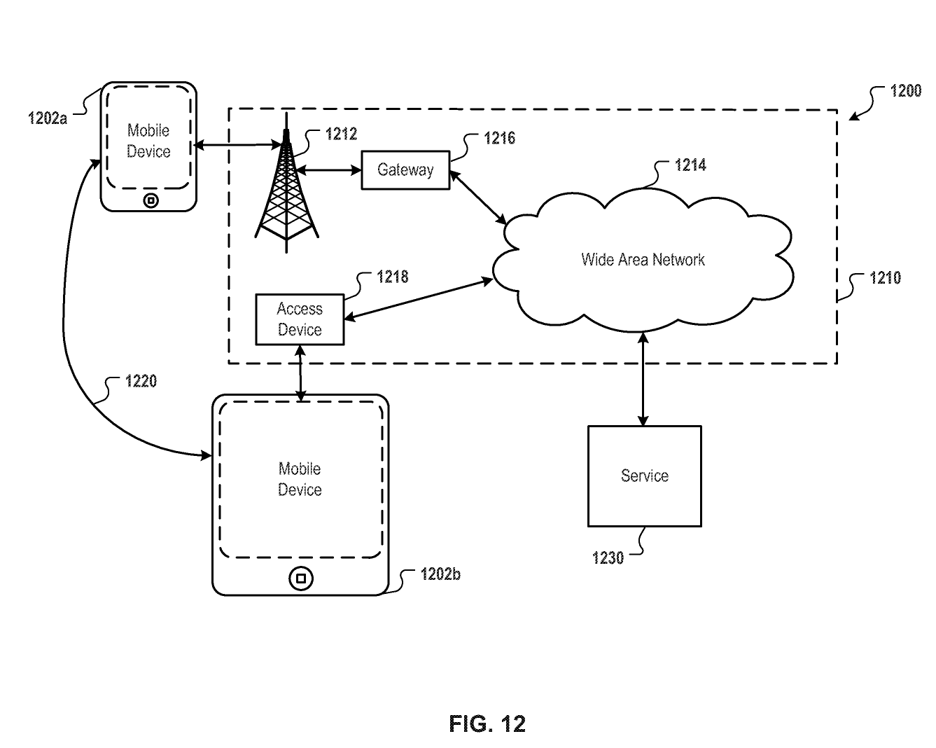

FIG. 12 illustrates an exemplary operating environment 1200 for a device that is capable of generating a GUI for tracking and displaying views of an application. In some implementations, devices 1202a and 1202b can for example, communicate over one or more wired and/or wireless networks 1210 in data communication. For example, a wireless network 1212, e.g., a cellular network, can communicate with a wide area network (WAN) 1214, such as the Internet, by use of a gateway 1216. Likewise, an access device 1218, such as an 802.11g wireless access device, can provide communication access to the wide area network 1214. Devices 1202 can be any device capable of displaying a GUI for tracking and displaying views of an application, including but not limited to portable computers, smart phones and electronic tablets. In some implementations, the device does not have to be portable but can be a desktop computer, television system, kiosk system or the like.

In some implementations, both voice and data communications can be established over wireless network 1212 and the access device 1218. For example, mobile device 1202a can place and receive phone calls (e.g., using voice over Internet Protocol (VoIP) protocols), send and receive e-mail messages (e.g., using Post Office Protocol 3 (POP3)), and retrieve electronic documents and/or streams, such as web pages, photographs, and videos, over wireless network 1212, gateway 1216, and wide area network 1214 (e.g., using Transmission Control Protocol/Internet Protocol (TCP/IP) or User Datagram Protocol (UDP)). Likewise, in some implementations, the mobile device 1202b can place and receive phone calls, send and receive e-mail messages, and retrieve electronic documents over the access device 1218 and the wide area network 1214. In some implementations, mobile device 1202a or 1202b can be physically connected to the access device 1218 using one or more cables and the access device 1218 can be a personal computer. In this configuration, mobile device 1202a or 1202b can be referred to as a “tethered” device.

Mobile devices 1202a and 1202b can also establish communications by other means. For example, wireless mobile device 1202a can communicate with other wireless devices, e.g., other mobile devices 1202a or 1202b, cell phones, etc., over the wireless network 1212. Likewise, mobile devices 1202a and 1202b can establish peer-to-peer communications 1220, e.g., a personal area network, by use of one or more communication subsystems, such as the Bluetooth™ communication devices. Other communication protocols and topologies can also be implemented.

The mobile devices 1202a or 1202b can for example, communicate with service 1230 over the one or more wired and/or wireless networks. For example, service 1230 can provide various services for providing a Web-based GUI for tracking and displaying views of an application that is hosted by service 1230.

Mobile device 1202a or 1202b can also access other data and content over the one or more wired and/or wireless networks. For example, content publishers, such as news sites, Really Simple Syndication (RSS) feeds, web sites, blogs, social networking sites, developer networks, etc., can be accessed by mobile device 1202a or 1202b. Such access can be provided by invocation of a web browsing function or application (e.g., a browser) in response to a user touching, for example, a Web object.

Exemplary Device Architecture

FIG. 13 is a block diagram illustrating exemplary device architecture that implements features and processes described in reference to FIGS. 1-13. Device 1300 can be any device capable of generating a GUI for tracking and displaying views of an application, including but not limited to portable or desktop computers, smart phones and electronic tablets, television systems, game consoles, kiosks and the like. Device 1300 can include memory interface 1302, data processor(s), image processor(s) or central processing unit(s) 1304, and peripherals interface 1306. Memory interface 1302, processor(s) 1304 or peripherals interface 1306 can be separate components or can be integrated in one or more integrated circuits. The various components can be coupled by one or more communication buses or signal lines.

Sensors, devices, and subsystems can be coupled to peripherals interface 1306 to facilitate multiple functionalities. For example, motion sensor 1310, light sensor 1312, and proximity sensor 1314 can be coupled to peripherals interface 1306 to facilitate orientation, lighting, and proximity functions of the mobile device. For example, in some implementations, light sensor 1312 can be utilized to facilitate adjusting the brightness of touch screen 1346. In some implementations, motion sensor 1310 (e.g., an accelerometer, gyros) can be utilized to detect movement and orientation of the device 1300. Accordingly, display objects or media can be presented according to a detected orientation, e.g., portrait or landscape.

Other sensors can also be connected to peripherals interface 1306, such as a temperature sensor, a biometric sensor, or other sensing device, to facilitate related functionalities.

Location processor 1315 (e.g., GPS receiver) can be connected to peripherals interface 1306 to provide geo-positioning. Electronic magnetometer 1316 (e.g., an integrated circuit chip) can also be connected to peripherals interface 1306 to provide data that can be used to determine the direction of magnetic North. Thus, electronic magnetometer 1316 can be used as an electronic compass.

Camera subsystem 1320 and an optical sensor 1322, e.g., a charged coupled device (CCD) or a complementary metal-oxide semiconductor (CMOS) optical sensor, can be utilized to facilitate camera functions, such as recording photographs and video clips.

Communication functions can be facilitated through one or more communication subsystems 1324. Communication subsystem(s) 1324 can include one or more wireless communication subsystems. Wireless communication subsystems 1324 can include radio frequency receivers and transmitters and/or optical (e.g., infrared) receivers and transmitters. Wired communication system can include a port device, e.g., a Universal Serial Bus (USB) port or some other wired port connection that can be used to establish a wired connection to other computing devices, such as other communication devices, network access devices, a personal computer, a printer, a display screen, or other processing devices capable of receiving or transmitting data. The specific design and implementation of the communication subsystem 1324 can depend on the communication network(s) or medium(s) over which device 1300 is intended to operate. For example, a mobile device can include communication subsystems 1324 designed to operate over a GSM network, a GPRS network, an EDGE network, a WiFi or WiMax network, and a Bluetooth network. In particular, the wireless communication subsystems 1324 can include For example, device 1300 may include wireless communication subsystems designed to operate over a global system for mobile communications (GSM) network, a GPRS network, an enhanced data GSM environment (EDGE) network, 802.x communication networks (e.g., WiFi, WiMax, or 3G networks), code division multiple access (CDMA) networks, and a Bluetooth™ network. Communication subsystems 1324 may include hosting protocols such that the mobile device 1300 may be configured as a base station for other wireless devices. As another example, the communication subsystems can allow the device to synchronize with a host device using one or more protocols, such as, for example, the TCP/IP protocol, HTTP protocol, UDP protocol, and any other known protocol.

Audio subsystem 1326 can be coupled to a speaker 1328 and one or more microphones 1330 to facilitate voice-enabled functions, such as voice recognition, voice replication, digital recording, and telephony functions.

I/O subsystem 1340 can include touch screen controller 1342 and/or other input controller(s) 1344. Touch-screen controller 1342 can be coupled to a touch screen 1346 or pad. Touch screen 1346 and touch screen controller 1342 can, for example, detect contact and movement or break thereof using any of a number of touch sensitivity technologies, including but not limited to capacitive, resistive, infrared, and surface acoustic wave technologies, as well as other proximity sensor arrays or other elements for determining one or more points of contact with touch screen 1346.

Other input controller(s) 1344 can be coupled to other input/control devices 1348, such as one or more buttons, rocker switches, thumb-wheel, infrared port, USB port, and/or a pointer device such as a stylus. The one or more buttons (not shown) can include an up/down button for volume control of speaker 1328 and/or microphone 1330.

In one implementation, a pressing of the button for a first duration may disengage a lock of the touch screen 1346; and a pressing of the button for a second duration that is longer than the first duration may turn power to mobile device 1300 on or off. The user may be able to customize a functionality of one or more of the buttons. The touch screen 1346 can also be used to implement virtual or soft buttons and/or a keyboard.

In some implementations, device 1300 can present recorded audio and/or video files, such as MP3, AAC, and MPEG files. In some implementations, device 1300 can include the functionality of an MP3 player and may include a pin connector for tethering to other devices. Other input/output and control devices can be used.

Memory interface 1302 can be coupled to memory 1350. Memory 1350 can include high-speed random access memory or non-volatile memory, such as one or more magnetic disk storage devices, one or more optical storage devices, or flash memory (e.g., NAND, NOR). Memory 1350 can store operating system 1352, such as Darwin, RTXC, LINUX, UNIX, OS X, WINDOWS, or an embedded operating system such as VxWorks. Operating system 1352 may include instructions for handling basic system services and for performing hardware dependent tasks. In some implementations, operating system 1352 can include a kernel (e.g., UNIX kernel).

Memory 1350 may also store communication instructions 1354 to facilitate communicating with one or more additional devices, one or more computers or one or more servers. Communication instructions 1354 can also be used to select an operational mode or communication medium for use by the device, based on a geographic location (obtained by the GPS/Navigation instructions 1368) of the device. Memory 1350 may include graphical user interface instructions 1356 to facilitate graphic user interface processing, such as generating the user interface element shown in FIGS. 1-10; sensor processing instructions 1358 to facilitate sensor-related processing and functions; phone instructions 1360 to facilitate phone-related processes and functions; electronic messaging instructions 1362 to facilitate electronic-messaging related processes and functions; web browsing instructions 1364 to facilitate web browsing-related processes and functions; media processing instructions 1366 to facilitate media processing-related processes and functions; GPS/Navigation instructions 1368 to facilitate GPS and navigation-related processes; camera instructions 1370 to facilitate camera-related processes and functions; and instructions for application 1372 (e.g., reporting application) that includes a GUI for tracking and displaying views, as described in reference to FIGS. 1-11. The memory 1350 may also store other software instructions for facilitating other processes, features and applications, such as applications related to navigation, social networking, location-based services or map displays.

Each of the above identified instructions and applications can correspond to a set of instructions for performing one or more functions described above. These instructions need not be implemented as separate software programs, procedures, or modules. Memory 1350 can include additional instructions or fewer instructions. Furthermore, various functions of the mobile device may be implemented in hardware and/or in software, including in one or more signal processing and/or application specific integrated circuits.

The features can be implemented in a computer system that includes a back-end component, such as a data server, that includes a middleware component, such as an application server or an Internet server, or that includes a front-end component, such as a client computer having a graphical user interface or an Internet browser, or any combination of them. The components of the system can be connected by any form or medium of digital data communication such as a communication network. Some examples of communication networks include LAN, WAN and the computers and networks forming the Internet.

The computer system can include clients and servers. A client and server are generally remote from each other and typically interact through a network. The relationship of client and server arises by virtue of computer programs running on the respective computers and having a client-server relationship to each other.

One or more features or steps of the disclosed embodiments can be implemented using an API. An API can define on or more parameters that are passed between a calling application and other software code (e.g., an operating system, library routine, function) that provides a service, that provides data, or that performs an operation or a computation. The API can be implemented as one or more calls in program code that send or receive one or more parameters through a parameter list or other structure based on a call convention defined in an API specification document. A parameter can be a constant, a key, a data structure, an object, an object class, a variable, a data type, a pointer, an array, a list, or another call. API calls and parameters can be implemented in any programming language. The programming language can define the vocabulary and calling convention that a programmer will employ to access functions supporting the API. In some implementations, an API call can report to an application the capabilities of a device running the application, such as input capability, output capability, processing capability, power capability, communications capability, etc.

A number of implementations have been described. Nevertheless, it will be understood that various modifications may be made. For example, other steps may be provided, or steps may be eliminated, from the described flows, and other components may be added to, or removed from, the described systems. Accordingly, other implementations are within the scope of the following claims.

What is claimed is:

1. A method comprising:
generating a graphical user interface (GUI) for displaying a selected view of an application; and
generating a user interface element of the GUI, the user interface element configured for displaying groups of one or more visual representations of views of the application, where the groups of views are in a compressed or expanded display format based on whether a member of the group corresponds to the selected view,
where the method is performed by one or more hardware processors.

2. The method of claim 1, further comprising:
receiving a first input selecting a compressed group of visual representations from the user interface element;
determining that a member of the selected group corresponds to the selected view; and
expanding the compressed group of visual representations in the user interface element.

3. The method of claim 1, further comprising:
receiving a first input selecting a compressed group of visual representations from the user interface element;
determining that a member of the selected group does not correspond to the selected view; and
expanding the compressed group of visual representations at least partially outside the user interface element.

4. The method of claim 1, where a groups of visual representations is visually augmented to indicate the status of one or more views in the group.

5. The method of claim 4, where augmenting includes changing a color or width of a border around a group of visual representations in the user interface element.

6. The method of claim 1, where the user interface element can be moved within the GUI by a user or application.

7. The method of claim 1, where the views are Web pages.

8. The method of claim 1, where the compressed display format is a stack.

9. The method of claim 1, where the expanded display format is one of a horizontal row of visual representations in the user interface element or a grid or path of visual representations displayed at least partially in the GUI.

10. A method comprising:
generating a graphical user interface (GUI) for displaying a selected view;
generating a user interface element for the GUI, the user interface element configured for displaying groups of visual representations of views;
receiving a first input selecting a group of visual representations from the user interface element; and
displaying visual representations in the GUI using a compressed or expanded display format, where the display format is selected based on whether a member of the selected group corresponds to the selected view, where the method performed by one or more hardware processors.

11. The method of claim 10, where a group of visual representations is visually augmented to indicate the status of one or more views in the group.

12. The method of claim 10, where the views are Web pages.

13. The method of claim 10, where the compressed display format is a stack.

14. The method of claim 10, where the expanded display format is one of a horizontal row of visual representations in the user interface element or a grid or path of visual representations displayed at least partially in the GUI.

15. A system comprising:
one or more processors;
memory coupled to the one or more processors and storing instructions, which, when executed by the one or more processors, causes the one or more processors to perform operations comprising:
generating a graphical user interface (GUI) for displaying a selected view of an application; and
generating a user interface element of the GUI, the user interface element configured for displaying groups of one or more visual representations of views of the application, where the groups of views are in a compressed or expanded display format based on whether a member of the group corresponds to the selected view, where the method is performed by one or more hardware processors.

16. The system of claim 15, further comprising:
receiving a first input selecting a compressed group of visual representations from the user interface element;
determining that a member of the selected group corresponds to the selected view; and
expanding the compressed group of visual representations in the user interface element.

17. The system of claim 15, further comprising:
receiving a first input selecting a compressed group of visual representations from the user interface element;
determining that a member of the selected group does not correspond to the selected view; and
expanding the compressed group of visual representations at least partially outside the user interface element.

18. The system of claim 15, where a groups of visual representations is visually augmented to indicate the status of one or more views in the group.

19. A system comprising:
one or more processors;
memory coupled to the one or more processors and storing instructions, which, when executed by the one or more processors, causes the one or more processors to perform operations comprising:
generating a graphical user interface (GUI) for displaying a selected view;
generating a user interface element for the GUI, the user interface element configured for displaying groups of visual representations of views;
receiving a first input selecting a group of visual representations from the user interface element; and
displaying visual representations in the GUI using a compressed or expanded display format, where the display format is selected based on whether a member of the selected group corresponds to the selected view, where the method performed by one or more hardware processors.

20. The method of claim 19, where a group of visual representations is visually augmented to indicate the status of one or more views in the group.

21. The system of claim 19, where the views are Web pages.

22. The method of claim 19, where the compressed display format is a stack.
